(19) United States
(12) Patent Application Publication
(10) Pub. No.: US 2009/0255132 A1
(43) Pub. Date: Oct. 15, 2009

(54) CARBIDE UTILITY SCORE

(76) Inventors: Brandon C. Hoover, Cornelius, NC (US); Daniel R. Seymour, Mooresville, NC (US); James M. Burry, Troutman, NC (US)

Correspondence Address: RONALD L. HOFER, 122 LINDBERGH LANE, MOORESVILLE, NC, 28117, US

(21) Appl. No.: 12/421,141

(22) Filed: Apr. 9, 2009

Related U.S. Application Data
(60) Provisional application No. 61/123,303, filed on Apr. 9, 2008.

(51) Int. Cl. B26B 29/00

(52) U.S. Cl. 30/293

(57) ABSTRACT

A carbide utility score tool has a carbide scoring blade as a primary cutting blade. The blade of the tool also has an edge file or saw and a flat file and the end of the tool handle has a striking cap for setting nails or the like.

### FIELD OF THE INVENTION

The present invention relates to a knife adapted to score or cut a notch or groove into a material. More particularly, in a preferred embodiment, the present invention relates to a multi-function folding carbide utility scoring tool having a blade with a scoring edge, a file or rasp and/or a saw, and having a handle with a striking cap.

### BACKGROUND OF THE INVENTION

Scoring tools are commonly used in construction and other industries but there remains room for improvement in such devices. For example, it would be advantageous to have a tool which could function not only as a scoring tool but also as other tools.

Also, it would be desirable to encourage the use of a hand tool such as a hand held scoring tool rather than a power tool if use of the power tool increased the user's personal risk. If improved scoring knives were available, they would be more likely to be used in place of tools which are used despite a health risk associated with their use. For example, fiber cement can be cut using a scoring tool but is commonly cut using a circular saw. This technique is disadvantageous, however, because it generates fiber cement dust which must be controlled to prevent it from posing a health risk to those who are exposed to it.

Cutting fiber cement using a “score and snap method” creates a safer cutting environment because the score and snap method generates less dust than a circular saw and the dust particles which are generated are larger than those from a circular saw. The score and cut method also works very well with a variety of different materials. It is an accurate, clean, simple way to cut without using electricity or any other outside power source. The process for cutting materials using the “score and snap method” is very simple. Score the surface of the material using the carbide tip and break along the scored line. Some materials, such as fiber cement, may be left with a jagged edge and would benefit from a secondary process of cleaning up the edge. A second tool, such as a file or a rasp, is then required to file the edge until it is clean

It is also common for a person working with materials such as fiber cement or linoleum to encounter a nail which is not completely set in a wall, ceiling or floor. When this occurs, the person must use a hammer or other suitable tool to drive the nail into the wall or ceiling or floor.

It would be desirable to have a single tool which combined the functions of a score, a file or rasp, a saw, and a hammer. Such a tool would facilitate cutting of many materials, and in particular, the cutting of fiber cement. Accordingly, the present invention provides a multi-function utility score which can function as a knife, a file or rasp, a saw, and a hammer. In use, the present invention allows a workman to handle four different tasks without changing tools. Of course, this invention is a hand tool which can cut a variety of different materials but which is particularly useful in scoring fiber cement.

The present invention provides an improved device for scoring, cutting and filing various materials including fiber cement board, siding, tile, plastic, glass, laminates, flooring and the like. Although the present invention is particularly well suited for cutting fiber cement, it is broadly useful in conjunction with a variety of materials. These and other advantages of the present invention will be apparent from the following description taken in conjunction with the accompanying drawings and following claims.

### SUMMARY OF THE INVENTION

The carbide utility score of this invention is a hand tool which has a carbide scoring blade as a primary cutting blade. The blade of the tool also has an edge file and or saw, a flat file or rasp and the end of the tool handle has a striking cap for setting nails or the like.

### DETAILED DESCRIPTION OF THE DRAWINGS

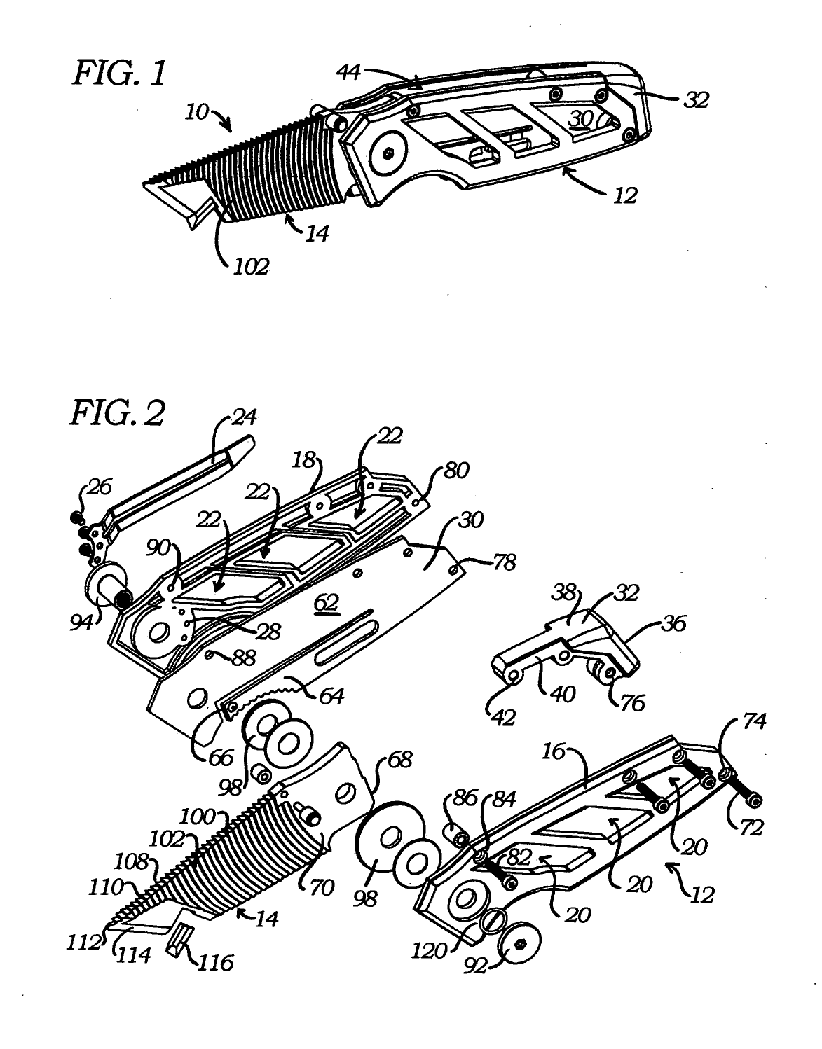

FIG. 1 is left perspective view of a preferred embodiment of a folding carbide utility score of the present invention with its blade in an opened configuration;

FIG. 2 is a left side exploded view of the score of FIG. 1 showing the individual components thereof;

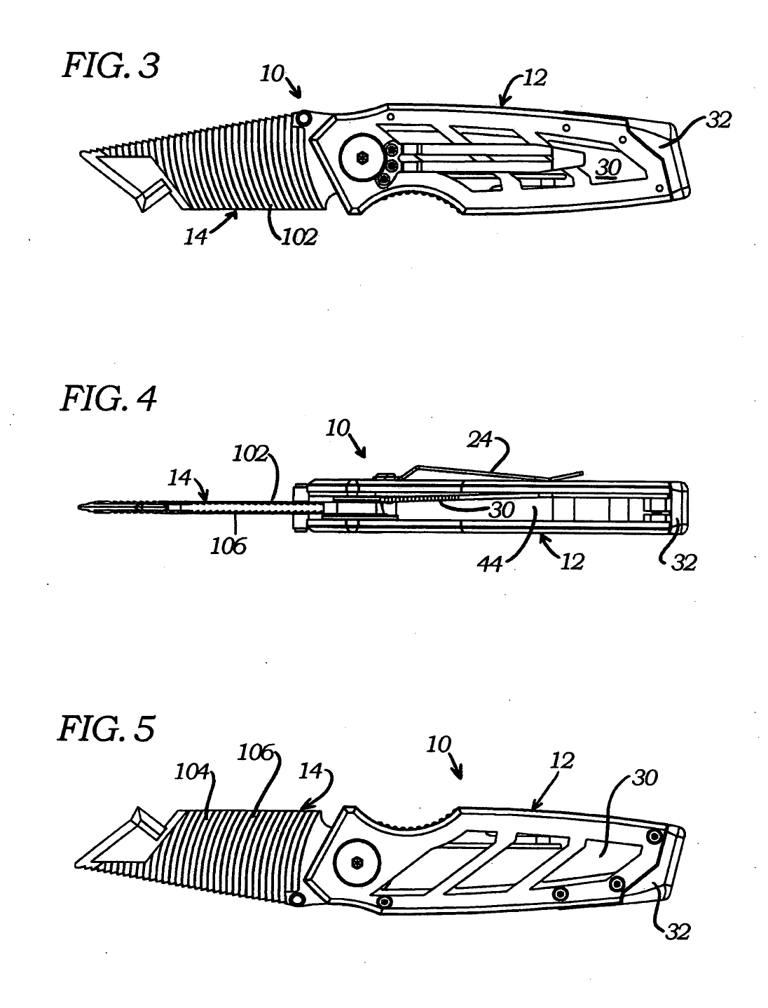

FIG. 3 is a left side elevational view of the score of FIG. 1 in open configuration;

FIG. 4 is a plan view of the score of FIG. 1 in open configuration;

FIG. 5 is a right side elevational view of the score of FIG. 1 in open configuration with the score having been rotated 180 degrees about its longitudinal axis;

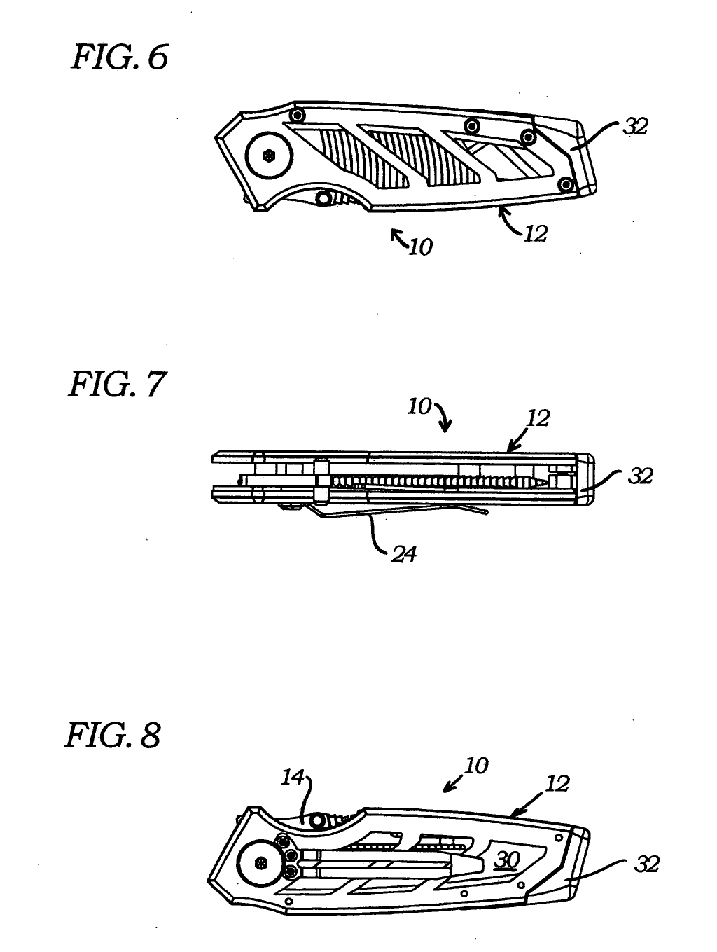

FIG. 6 is a left side elevational view of the score of FIG. 1 in closed configuration;

FIG. 7 is a plan view of the score of FIG. 1 in closed configuration; and

FIG. 8 is a right side elevational view of the score of FIG. 1 in closed configuration with the score having been rotated 180 degrees about its longitudinal axis.

### DESCRIPTION OF THE INVENTION

Now referring to FIGS. 1-8, a preferred embodiment of a folding carbide utility score is shown and indicated generally by the numeral 10. Generally speaking, score 10 comprises handle assembly 12 and blade assembly 14 which are described in more detail below.

Handle assembly 12 has first body half 16 and second body half 18, one body half being generally a mirror image of the other body half. First body half 16 and second body half 18 have open spaces 20 and 22 respectively to reduce the weight of handle assembly 12 and to improve the aesthetics of tool 10 and are fastened together in the manner disclosed in the following paragraphs to hold and contain other elements of handle assembly 12 as well as blade assembly 14. A pocket clip 24 is attached to second body half 18 by a plurality of threaded fasteners 26 which threadably engage holes 28 in second body half 18. Pocket clip 24 is preferably made of spring steel or the like and is useful for attaching tool 10 to a pocket of a user.

Handle assembly 12 has, located generally between first and second body halves 16 and 18, blade lock mechanism 30 and striking cap 32. Body halves 16 and 18 can be made of aluminum, plastic, or other suitable materials. Blade lock mechanism 30 and striking cap 32 are preferably made of steel but can be made of any material which is found to be suitable for their respective functions.

Striking cap 32 has rearwardly facing striking face 36 and an upwardly facing alternate striking face 38 which are adapted for driving nails, staples or the like. Striking cap 32 also has forwardly extending, reduced thickness neck 40 with holes 42 therethrough. Forwardly extending neck 40 secures striking cap 32 to body halves 16 and 18 and has a width to space the body halves apart to provide an interior space 44 to contain blade assembly 14 and blade lock mechanism 30.

Blade lock mechanism 30 has a planar spring steel sheet member 62 with finger 64 bent toward first body half 16. Finger 64 is normally not coplanar with sheet member 62 but and assumes a locking position with its forward end 66 abutting against rearward end 68 of blade member 70 to lock blade assembly 14 in its operating position as shown in FIGS. 1-5. Forward end 66 of finger 64 can be manipulated toward second body half 18 to unlock blade assembly 14 to thereby allow pivotal movement of blade member 14 to its stored position as shown in FIGS. 6-8.

First body half 16 is fastened to second body half 18 and handle assembly 12 and its various parts are secured thereto by means of a plurality of cap screws 72 which extend through holes 74 in first body half 16, holes 76 in striking cap 32, holes 78 in steel sheet member 62 and into threaded holes 80 in second body half 18. Forward cap screw 82 extends through hole 84 in first body half 16, through tubular spacer 86, through hole 88 in steel sheet member 62 and into threaded hole 90 in second body half 18. First body half 16 is also fastened to second body half 18 by male pivot screw 92 which is received in female pivot screw 94 which also serve to secure blade assembly 14 to handle assembly 12. O-ring 120 provides friction to improve the feel of the user when pivoting blade assembly 14 with respect to handle assembly 12. A plurality of washers 98 are provided to facilitate pivotal movement of blade assembly 14 with respect to handle assembly 12.

Blade assembly 14 has a blade member 70 with left side face 100 having grooves 102 cut therein and right side face 104 having grooves 106 cut therein to function as a files or rasps while edge 108 of blade member 70 has grooves 110 cut therein to function as a file or rasp. Alternatively, edges 104 and 108 can have grooves or teeth therein to function as a cutting saw. The forward end of blade member 70 is shaped into a point 112 which can be used as a punch tool while forward edge 114 is sharpened and suitable for scoring. A carbide tip 116 is brazed, welded or attached to the end of blade member 70 to form blade assembly 14 and can be used as the primary scoring tool. Blade member 70 is heat treated and can be machined, formed or rolled with an aggressive file texture on one, two, three, or all four sides. The file and rasps can be used to clean up any jagged edges of the materials which have been cut. The blade is formed into a tip which can be helpful for jabbing holes.

The carbide utility score of the present invention has many desired features which will be useful to end users in cutting a variety of different materials with one tool. It does not require outside power sources and can be used anywhere. It solves the problem of having to have multiple tools to complete the score or cut method on a variety of materials. Most importantly, it offers a safe, dust free cutting method for fiber cement.

While a preferred embodiment of a tool of the present invention has been disclosed and described above, it will be appreciated by those skilled in the art that the present invention is subject to modifications and variations. For example, the blade assembly maybe fixedly attached to the handle assembly or slidingly attached thereto. Also, the blade assembly may have edges with saw teeth or file grooves or a combination of both. The blade assembly and handle assembly can be made of several different materials so long as the materials are consistent with the function of the present invention. For example, stainless steel can be used instead of spring steel. Such modifications and variations are within the spirit of the present invention which is intended to be limited only by the following claims. The screws and threaded holes can be replaced with bolts and nuts.

What is claimed is:

1. A carbide utility score comprising a handle assembly and a blade member,
said handle assembly having a forward portion and a rearward portion and a hollow interior portion; and
said blade member carrying a carbide cutting blade and having a body with an edge having filing grooves cut therein and a side face having rasp grooves cut therein.

2. A carbide utility score as in claim 1 wherein said handle assembly carries a striking cap on said rearward portion thereof.

3. A carbide utility score as in claim 1 wherein said blade member has a left planar side and a right planar side and upper and lower edges and has grooves cut into at least one of said left and right planar sides and at least one of said upper and lower edges.

4. A carbide utility score as in claim 3 wherein said blade member has grooves cut into each of said left and right planar sides and at least one of said upper and lower edges.

5. A carbide utility score as in claim 3 wherein said blade member has grooves cut into each of said left and right planar sides and each of said upper and lower edges.

6. A carbide utility score as in claim 1 wherein said blade member is pivotally attached to said forward portion of said handle assembly and is adapted to pivot between an operable position outside of said hollow interior of said handle assembly and a storage position substantially within said hollow interior.

7. A carbide utility score as in claim 6 wherein said score has a blade lock mechanism located in said hollow interior of said handle assembly.
